(19) United States
(12) Patent Application Publication
(10) Pub. No.: US 2015/0070496 A1
(43) Pub. Date: Mar. 12, 2015

(54) REFLECTING TELESCOPE

(71) Applicant: CANON KABUSHIKI KAISHA, Tokyo (JP)

(72) Inventor: Toru Matsuda, Utsunomiya-shi (JP)

(21) Appl. No.: 14/481,263

(22) Filed: Sep. 9, 2014

(30) Foreign Application Priority Data
Sep. 11, 2013 (JP) 2013-188224

(51) Int. Cl. G02B 23/06; H04N 7/18

(52) U.S. Cl. CPC G02B 23/06; H04N 7/18
USPC 348/144

(57) ABSTRACT

A reflecting telescope includes a reflecting mirror having an image forming function, a correction optical system configured to receive light reflected at the reflecting mirror, and including a compound lens including a positive lens and a negative lens in which a difference of refractive indexes of materials is 0.5% or more, and configured to be moved in a direction having a component of a vertical direction with respect to an optical axis, an image sensor configured to receive the light through the correction optical system, a detecting unit configured to detect a driving amount of the compound lens, and a control unit configured to tilt the image sensor with respect to the optical axis based on the driving amount of the compound lens detected by the detecting unit.

### BACKGROUND OF THE INVENTION

1. Field of the Invention

The present invention relates to a reflecting telescope including a reflecting mirror having an image forming function, a correction optical system that corrects image forming performance of the reflecting mirror, and an image sensor, and capable of favorably performing astronomical observation with a wide field.

2. Description of the Related Art

Reflecting telescopes used for astronomical observation have a higher resolution of an astronomical object to be observed as an aperture is larger. Therefore, to observe a distant astronomical object with a high resolution, it is necessary to have a large aperture. In the astronomical observation, deviation is caused in a star image by a wavelength of light due to atmospheric dispersion in observation other than the zenith. Therefore, the star image is blurred, and an inherent resolution may not be obtained even if a reflecting telescope having a large aperture is used.

The applicant of the present application discusses an astronomical telescope (reflecting telescope) including an aberration correction system that corrects such atmospheric dispersion (see U.S. Pat. No. 6,038,068).

The aberration correction system discussed in U.S. Pat. No. 6,038,068 is arranged adjacent to a focal position of a primary mirror (reflecting mirror) that forms a part of the astronomical telescope, and corrects an aberration that the primary mirror has, and the atmospheric dispersion. Accordingly, the astronomical telescope enables astronomical observation with a brighter and wider field and a higher resolution than a case where, for example, an astronomical object is observed with a Cassegrain reflecting telescope in which a primary mirror and a sub-mirror are combined.

The astronomical telescope discussed in U.S. Pat. No. 6,038,068 performs, in the aberration correction system including a compound lens including a pair of lenses made of materials having mutually different dispersion, correction of the atmospheric dispersion by moving the compound lens in a vertical direction with respect to an optical axis. This enables downsizing of the entire lens system, and favorable correction of both of the aberration of the primary mirror and a chromatic aberration due to the atmospheric dispersion. As materials used for the compound lens for atmospheric dispersion correction (hereinafter, may also be referred to as atmospheric dispersion corrector or ADC), it is favorable to select materials in which the refractive indexes are almost the same and only the dispersion is different.

With the selection of the materials, the compound lens (ADC) becomes optically equivalent to a flat plate glass in a principal wavelength, and becomes unlikely to influence other aberrations even if the ADC moves. In a case where the compound lens (ADC) is relatively small, there are some materials that can be used for the compound lens (ADC) and relatively satisfy the above requirements. For example, in the combination of the materials used for the compound lens used in the exemplary embodiment of U.S. Pat. No. 6,038,068, a difference between the refractive indexes is about 0.5% or less.

The field of view (FOV) of the astronomical telescope using the aberration correction system of U.S. Pat. No. 6,038,068 is 0.5°. In recent years, further improvement of survey performance of astronomical telescopes is desired, and thus a wider field of the aberration correction system is demanded. The applicant of the present application discusses reflecting telescopes using principal focus correction optical systems (aberration correction systems) that cause the FOV to be wider to 1.5° to 1.9°, and may be able to realize a favorable star image (see Japanese Patent Application Laid-Open No. 2009-036976, Japanese Patent Application Laid-Open No. 2009-223019, and U.S. Pat. No. 8,427,745).

According to the study of the inventors of the present application, it has been found out that, to make the FOV wider to 1.5° or more and to observe a favorable star image, it is necessary to make diameters of single lenses and the compound lens included in the aberration correction system (hereinafter, may also be referred to as principal focus correction optical system) larger. When the compound lens becomes large, difficulty in manufacturing of the materials is increased. Therefore, usable types of the materials are restricted. As a result, it becomes difficult to obtain a combination of materials in which the difference between the refractive indexes of the two materials that form the compound lens is 0.5% or less, and only the dispersion is different.

The principal focus correction optical systems discussed in Japanese Patent Application Laid-Open No. 2009-036976 and Japanese Patent Application Laid-Open No. 2009-223019 have overcome such restriction of the materials and have realized high image forming performance by devising of optical arrangement. Now, assume that the compound lens is formed of a combination of lenses made of two materials having a considerable difference between the refractive indexes of the materials.

At this time, the chromatic aberration due to the atmospheric dispersion is corrected by movement of the compound lens. However, considerable aberration deterioration is caused. More specifically, when imaging an astronomical object adjacent to the zenith, the reflecting telescope can image the astronomical object with an extremely favorable resolution. However, when changing a moving amount of the compound lens following up change of an altitude angle (separation angle) of the astronomical object, the reflecting telescope has a resolution more decreased than the vicinity of the zenith due to the aberration deterioration.

The exemplary embodiments described above cause the aberration deterioration to fall within a permissible range even if the moving amount of the compound lens is large by optimizing an optical parameter. However, to further improve the resolution, it becomes important to make the aberration deterioration smaller even if the moving amount of the compound lens is large.

### SUMMARY OF THE INVENTION

The present invention is directed to a reflecting telescope having an atmospheric dispersion correction function, and capable of favorably observing an astronomical object in a state of a large FOV.

According to an aspect of the present invention, a reflecting telescope includes a reflecting mirror having an image forming function, a correction optical system configured to receive light reflected at the reflecting mirror, and including a compound lens including a positive lens and a negative lens in which a difference of refractive indexes of materials is 0.5% or more, and configured to be moved in a direction having a component of a vertical direction with respect to an optical axis, an image sensor configured to receive the light through the correction optical system, a detecting unit configured to detect a driving amount of the compound lens, and a control unit configured to tilt the image sensor with respect to the optical axis based on the driving amount of the compound lens detected by the detecting unit.

Further features of the present invention will become apparent from the following description of exemplary embodiments with reference to the attached drawings.

### BRIEF DESCRIPTION OF THE DRAWINGS

FIG. 1 is a diagram illustrating an optical arrangement of a reflecting telescope according to a first exemplary embodiment.

FIG. 2 is a diagram illustrating a configuration of a principal focus correction optical system used in the reflecting telescope according to the first exemplary embodiment.

FIG. 3 is a vertical aberration diagram illustrating the reflecting telescope according to the first exemplary embodiment.

FIG. 4 is a lateral aberration diagram illustrating the reflecting telescope according to the first exemplary embodiment.

FIG. 5 is a conceptual diagram illustrating a configuration for correcting aberration deterioration due to movement of a compound lens in the reflecting telescope according to the first exemplary embodiment.

FIG. 6 is an encircled energy diagram illustrating image forming performance in a state of observation in the zenith direction in which the compound lens is not driven, according to the first exemplary embodiment.

FIG. 7 is an encircled energy diagram illustrating image forming performance in a state of observation in a direction of a zenith distance of 60 degrees in which the compound lens is driven at the maximum, according to the first exemplary embodiment.

FIG. 8 is an encircled energy diagram illustrating image forming performance after a tilt of an image sensor is corrected in the state of observation in a direction of a zenith distance of 60 degrees in which the compound lens is driven at the maximum, according to the first exemplary embodiment.

### DESCRIPTION OF THE EMBODIMENTS

Hereinafter, a reflecting telescope according to an exemplary embodiment the present invention will be described with reference to the drawings.

The reflecting telescope according to the present exemplary embodiment includes a reflecting mirror having an image forming function, a correction optical system (principal focus correction optical system) that corrects an image focused by the reflecting mirror, and an image sensor that photo-electrically converts the focused image (converts the focused image into an electrical signal).

The correction optical system is made of a positive lens and a negative lens in which refractive indexes of materials are different from each other by 0.5% or more, and a compound lens moved in a direction having a component of a vertical direction with respect to an optical axis. In the present exemplary embodiment, the refractive indexes of the materials being different from each other by 0.5% or more can be rephrased by a difference between the refractive indexes of the two lenses being 0.5% or more of the refractive index of a lens having a higher refractive index. In other words, the refractive indexes of the materials being different from each other by 0.5% or more means that the refractive index of a lens having a lower refractive index is 99.5% or less, or 100.5% or more of the refractive index of a lens having a higher refractive index. Further, similarly, expression of a difference between the refractive indexes being 5% or less means that the difference between the refractive indexes is 5% or less based on the lens having a higher refractive index.

The reflecting telescope includes a detecting unit that detects a driving amount of the compound lens, and a calculation unit that calculates a correction amount of a tilt of the image sensor with respect to the optical axis from the driving amount of the compound lens detected by the detecting unit. Further, the reflecting telescope includes a control unit that controls and drives a moving amount of the compound lens and a tilt amount of the image sensor from the correction amount calculated by the calculation unit. The tilt amount of the image sensor is changed according to the moving amount of the compound lens.

A driving unit, such as a linear motor, moves the compound lens and a tilt driving unit using a piezo-actuator drives the image sensor. A zenith distance detecting unit measures a angle from the zenith of an astronomical object observed through the reflecting telescope, and the moving amount of the compound lens is determined based on a measurement result of the separation angle or according to an input signal (separation angle signal) from an external input unit.

To finely adjust a tilt of an image plane caused by movement of the compound lens, the tilt of the image sensor is adjusted. Accordingly, optical performance of the reflecting telescope over the entire image plane is favorably maintained.

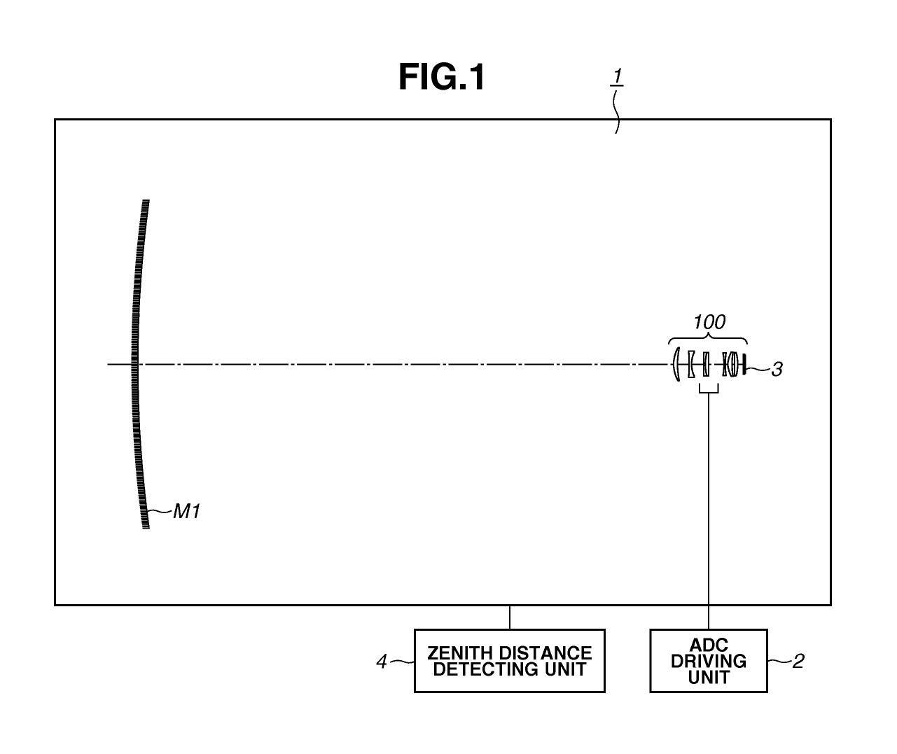

FIG. 1 is a diagram illustrating optical arrangement of the reflecting telescope including the correction optical system according to the first exemplary embodiment of the present invention.

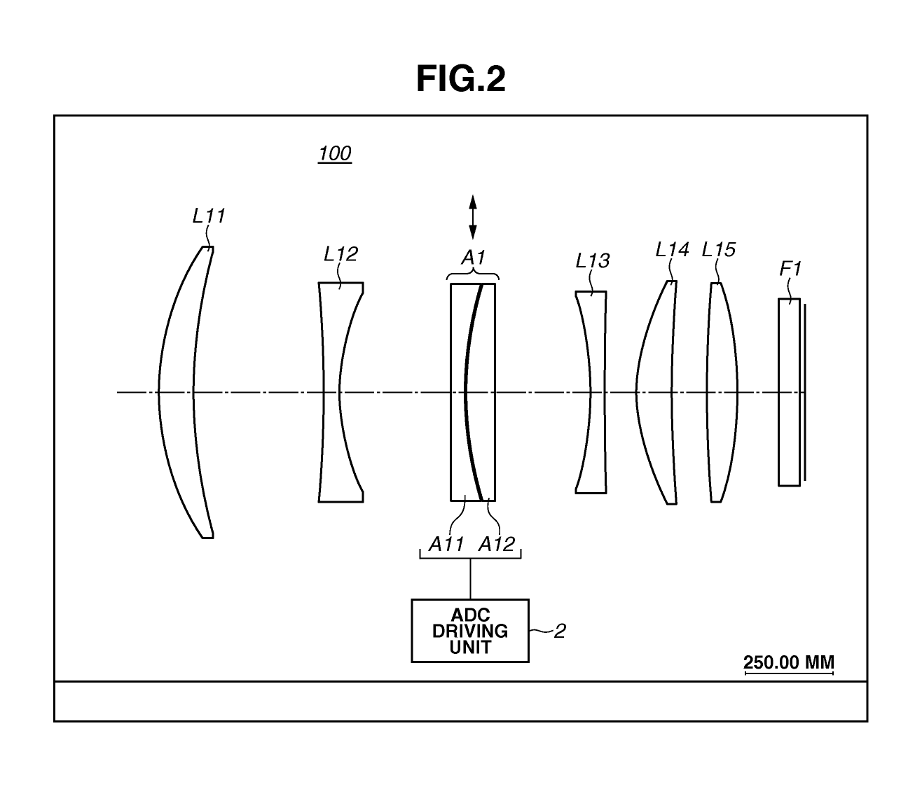

FIG. 2 is an enlarged diagram illustrating the correction optical system in FIG. 1.

FIG. 1 illustrates a reflecting telescope 1. The reflecting telescope 1 includes a primary mirror M1 having an image forming function, and a correction optical system 100. The primary mirror M1 is a concave hyperboloidal mirror. The correction optical system 100 is arranged adjacent to a focal point of the primary mirror M1, and corrects an aberration caused by the primary mirror M1. A light flux from an astronomical object is incident on the primary mirror M1 from a right side in FIG. 1, reflected at the primary mirror M1, then focused on an imaging plane C1 on which an image sensor (imaging unit) 3 is arranged, through the correction optical system 100.

An ADC driving unit 2 moves a compound lens A1 that forms a part of the correction optical system 100 in a vertical direction with respect to an optical axis. A zenith distance detecting unit 4 detects an angle of the reflecting telescope 1 from the zenith.

A configuration of the correction optical system 100 illustrated in FIG. 2 will be described. The correction optical system 100 includes lenses L11 to L15 and the compound lens A1. The shapes of the five lenses L11 to lens L15 of the correction optical system 100 is optimized.

More specifically, the correction optical system includes a first lens L11, a second lens L12, and the compound lens (ADC) A1 for atmospheric dispersion correction (atmospheric chromatic dispersion correction) made of two single lenses in order from the primary mirror M1 side to the imaging plane C1 side. Further, a third lens L13, a fourth lens L14, and a fifth lens L15 are arranged in order. Light coming from an astronomical object is reflected at the primary mirror M1, passes through the first lens L11, the second lens L12, the compound lens (A1), the third lens L13, the fourth lens L14, and the fifth lens L15 of the correction optical system 100 in order, and then forms an image of the astronomical object on the imaging plane C1 of the imaging unit 3.

Accordingly, the correction optical system 100 favorably corrects the aberration within a range of the FOV of 1.6 degrees. However, to avoid an increase in size, an effective diameter within an effective FOV of 1.5 degrees is determined. F1 represents a filter for selecting a transmission wavelength band and a parallel flat plate corresponding to the thickness of a window material of a charge-coupled device (CCD) Dewar.

The compound lens A1 includes two lenses of a negative lens A11 and a positive lens A12 made of materials having mutually different refractive indexes and different dispersion. The ADC driving unit 2, including an actuator and a moving mechanism, moves the compound lens A1 to have a component of a direction perpendicular to the optical axis (in the direction of the arrow in the drawing), thereby correcting color shifts due to the atmospheric dispersion.

The compound lens A1 includes the pair of lenses A11 and A12 made of materials in which the refractive indexes are different from each other by 0.5% or more, and the dispersion are different from each other. The lenses A11 and A12 are bonded or adjacently arranged with a slight air distance (air layer) in the optical axis direction. Here, the positive lens and the negative lens included in the compound lens A1 are desirably arranged with the air distance as described above (interposing the air layer). More favorably, mutually facing surfaces (a surface of the positive lens of the negative lens side and a surface of the negative lens of the positive lens side) have different curvature radiuses from each other in order to avoid harmful ghosts. A difference between the curvature radiuses is 0.5% or more of whichever larger curvature radius (favorably, 1.0% or more), and more favorably, the difference is 5.0% or less (favorably, 3.0% or less).

More specifically, a refractive index nd of the material (product name: BSL7Y) that forms the lens (first lens) A11 is 1.51633, and the Abbe number νd is 64.2. Further, the refractive index nd of the material (product name: PBL1Y) that forms the lens (second lens) A12 is 1.54814, and the Abbe number νd is 45.8.

A ratio of the refractive indexes of the materials of the lenses A11 and A12 of this time is:

1.51633/1.54814=0.979

That is, the refractive indexes are different from each other by 2.1%.

The compound lens A1 according to the present exemplary embodiment includes the positive lens (lens A12) and the negative lens (lens A11) in which the refractive indexes of the materials are different from each other by 0.5% or more (favorably, 5% or less), the lenses A11 and A12 being adjacently arranged in the optical axis direction.

These materials are combined, and furthermore, facing lens surfaces have similar curvatures (a difference between the curvature radiuses is ±5% or less). In other words, the lenses A11 and A12 satisfy a conditional expression of:

0.95<Rn/Rp<1.05

where the curvature radiuses of the facing lens surfaces are Rp and Rn, respectively.

Accordingly, when the compound lens A1 is moved in a direction perpendicular to the optical axis and the atmospheric dispersion is corrected, a necessary amount of a chromatic aberration is generated. In addition, the refractive index nd is a refractive index with respect to a d line (587.6 nm). The Abbe number νd is defined as follows:

νd=(nd −1)/(nF−nC)

where nd: a refractive index with respect to the d line (587.6 nm),
nF: a refractive index with respect to an F line (486.1 nm), and
nC: a refractive index with respect to a C line (656.3 nm).

Further, the lens A11 has a plane surface at the object side (primary mirror M1 side) and the lens A12 has a plane surface on the imaging plane (C1) side. That is, both of a light incident surface and a light emission surface of the compound lens A1 are planes.

Accordingly, regarding a monochromatic ray, effect of when the compound lens A1 is moved in a direction perpendicular to the optical axis is not much different from that of a case where a simple flat plate glass is moved, and change of the monochromatic aberration is maintained small.

Next, numerical value data of the first exemplary embodiment of the reflecting telescope 1 is illustrated in Table 1. A surface number in the table is a number given to each surface in a proceeding order of the light flux from the astronomical object side. “i” represents an order of the surface from the astronomical object. Ri represents the curvature radius of each surface, and di represents a distance between the i-th surface and the (i+1)th surface. R1 is the primary mirror, and R2 to R15 are surfaces of the correction optical system 100.

As the materials, silica, and two types of materials, product names of which are BSL7Y and PBL1Y, are used. More specifically, silica has the refractive index nd of 1.45846, and the Abbe number νd of 67.8. The material BSL7Y has the refractive index nd of 1.51633, and the Abbe number νd of 64.2. The material PBL1Y has the refractive index nd of 1.54814, and the Abbe number νd of 45.8. While the name of the materials used in the exemplary embodiment are a glass name of OHARA Inc., other equivalent products may be used.

The correction optical system 100 of the present exemplary embodiment includes five aspheric surfaces. The shape of the aspheric surfaces is expressed by formula (1):

$$z = \frac{( 1 / R ) {h}^{2}}{1 + \sqrt{1 - ( 1 + k ) {( h / R )}^{2}}} + {Ah}^{4} + {Bh}^{6} + {Ch}^{8} + {Dh}^{10} + {Eh}^{12} + {Fh}^{14} + {Gh}^{16} \qquad formula ( 1 )$$

where a z axis is in the optical axis direction, an h axis is in the vertical direction to the optical axis, a traveling direction of light is positive, R is a paraxial curvature radius, k is a conic constant, and A to G are the 4th to 16th aspheric surface coefficients.

Further, in Table 1, “f” represents a combined focal length of the primary mirror M1 and the correction optical system 100, FNO represents an F-number, and 2ω represents a total angle of view (field angle) (degree).

In the present exemplary embodiment, the operator has adjusted various optical values to obtain favorable image forming performance in an environment of the temperature of 0° C. and the atmospheric pressure of 600 mbar, assuming that the reflecting telescope 1 including the correction optical system 100 is installed at a high mountain suitable for astronomical object observation.

TABLE 1
f = 18320 mm FNO = 2.23 2ω = 1.5°

| Surface | Curvature | Surface | | Effective |
|---|---|---|---|---|
| Number | Radius R | Interval d | Material | Diameter |
| 1 | 30000.0000 | 13455.0000 | | 8200.0 |
| (primary | (aspheric | | | |
| mirror) | surface) | | | |
| 2 | 760.0000 | 98.0000 | SILICA | 820.0 |
| 3 | 1375.1117 | 372.4491 | | 804.5 |
| | (aspheric | | | |
| | surface) | | | |
| 4 | −3535.0517 | 46.0000 | BSL7Y | 615.5 |
| | (aspheric | | | |
| | surface) | | | |
| 5 | 656.2499 | 317.9915 | | 573.4 |
| 6 (ADC) | ∞ | 40.0000 | BSL7Y | 609.5 |
| 7 (ADC) | 1058.0000 | 3.0000 | | 607.8 |
| 8 (ADC) | 1040.0000 | 82.0000 | PBL1Y | 608.9 |
| 9 (ADC) | ∞ | 274.2607 | | 607.6 |
| 10 | −840.0002 | 40.0000 | PBL1Y | 551.9 |
| | (aspheric | | | |
| | surface) | | | |
| 11 | 9800.0000 | 90.0000 | | 567.9 |
| 12 | 480.0000 | 102.0000 | BSL7Y | 627.3 |
| | (aspheric | | | |
| | surface) | | | |
| 13 | 4021.7590 | 100.0000 | | 624.3 |
| 14 | 4176.7484 | 88.0000 | SILICA | 616.5 |
| 15 | −1272.8223 | 118.5964 | | 613.5 |
| | (aspheric | | | |
| | surface) | | | |
| 16 | ∞ | 58.0000 | SILICA | 525.0 |
| (Filter) | | | | |
| 17 | ∞ | 15.0000 | | 504.2 |
| (Filter) | | | | |
| 18 | ∞ | — | — | 496.2 |
| Imaging | | | | |
| Plane | | | | |

(Aspheric Surface)

| | | | | |
|---|---|---|---|---|
| Sur- | k | A (4th) | B (6th) | C (8th) |
| face | −1.00835 | 0.00000 | 0.00000 | 0.00000 |
| 1 | D (10th) | E (12th) | F (14th) | G (16th) |
| | 0.00000 | 0.00000 | 0.00000 | 0.00000 |
| Sur- | k | A (4th) | B (6th) | C (8th) |
| face | 0.00000 | −1.5010E−10 | −7.8810E−17 | −7.3909E−22 |
| 3 | D (10th) | E (12th) | F (14th) | G (16th) |
| | 1.0128E−26 | −7.1216E−32 | 2.6165E−37 | −3.8976E−43 |
| Sur- | k | A (4th) | B (6th) | C (8th) |
| face | 0.00000 | 6.8480E−11 | 5.6166E−16 | −1.3924E−20 |
| 4 | D (10th) | E (12th) | F (14th) | G (16th) |
| | 3.3242E−25 | −4.3715E−30 | 2.9654E−35 | −8.1533E−41 |
| Sur- | k | A (4th) | B (6th) | C (8th) |
| face | 0.00000 | 2.7685E−09 | −4.8556E−14 | 7.1761E−19 |
| 10 | D (10th) | E (12th) | F (14th) | G (16th) |
| | −1.0764E−23 | 1.1874E−28 | −7.9838E−34 | 2.3936E−39 |
| Sur- | k | A (4th) | B (6th) | C (8th) |
| face | 0.00000 | −4.3555E−09 | 3.6359E−14 | −5.9513E−19 |
| 12 | D (10th) | E (12th) | F (14th) | G (16th) |
| | 7.6588E−24 | −7.1941E−29 | 3.9428E−34 | −9.5434E−40 |
| Sur- | k | A (4th) | B (6th) | C (8th) |
| face | 0.00000 | −1.0647E−09 | 3.3778E−15 | −1.1026E−19 |
| 15 | D (10th) | E (12th) | F (14th) | G (16th) |
| | 2.2824E−24 | −2.7430E−29 | 1.7558E−34 | −4.8219E−40 |

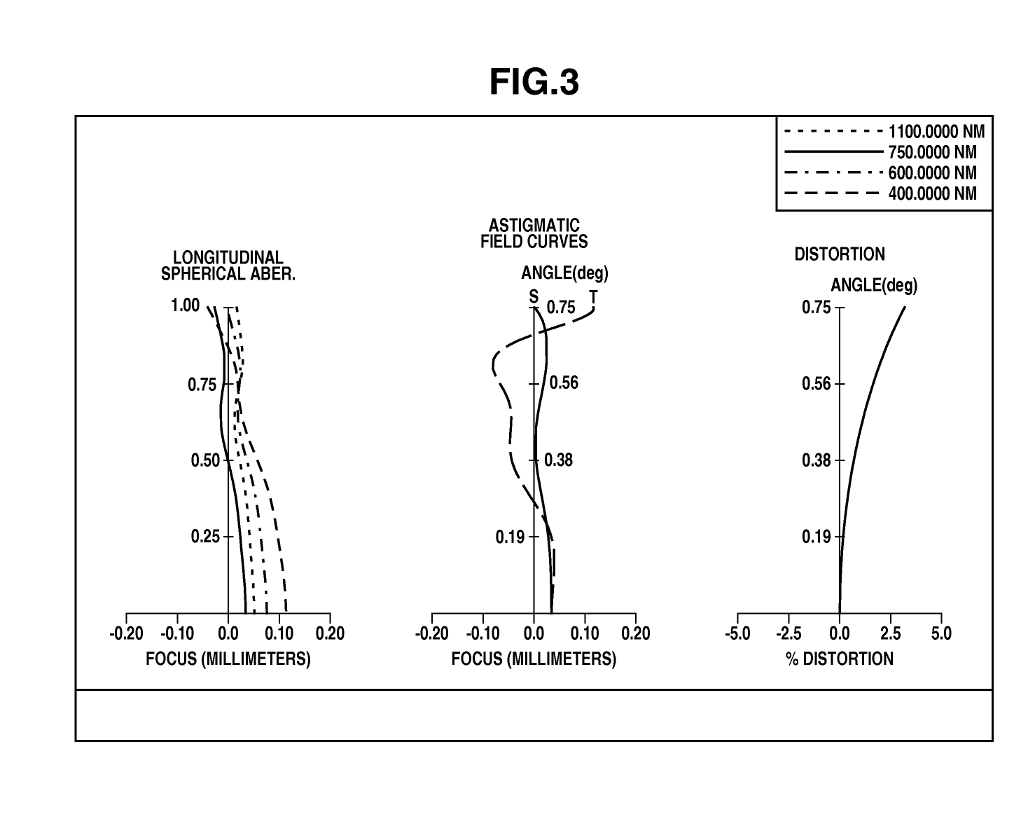

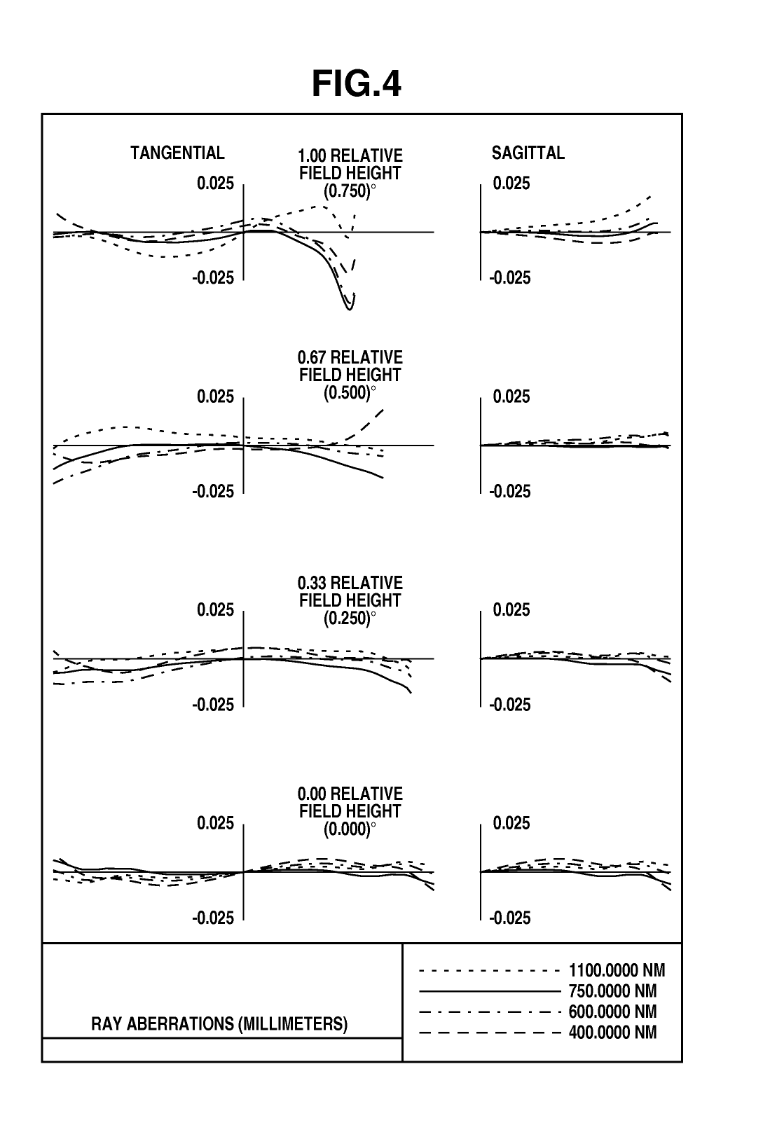

FIGS. 3 and 4 are aberration diagrams of the reflecting telescope 1 according to the first exemplary embodiment. FIG. 3 is a vertical aberration diagram and FIG. 4 is a lateral aberration diagram. As is clear from the aberration diagrams, the reflecting telescope 1 using the principal focus correction optical system 100 according to the present exemplary embodiment has an atmospheric dispersion correction function and has favorable image forming performance in which a star image diameter falls within root-mean-square (RMS) 0.3 arcseconds in the entire field angle of 1.5 degrees.

In the reflecting telescope of the first exemplary embodiment, there is no influence of the atmospheric dispersion when an astronomical object to be observed is in the zenith direction, and thus it is not necessary to move the compound lens A1. When the astronomical object detected by the zenith distance detecting unit 4 exists in a direction of 60 degrees from the zenith direction, the moving amount of the compound lens A1 becomes about 22 mm, which is the maximum amount.

In the present exemplary embodiment, the zenith distance may be input from the outside through an input unit without using the zenith distance detecting unit 4, and the compound lens A1 may be driven based on the value.

Even when the compound lens A1 is moved by about 22 mm with respect to the optical axis, the aberration is relatively favorably maintained. However, compared with observation in the zenith direction where the compound lens A1 is not moved, the image forming performance is decreased due to a coma aberration and a tilt of the image plane. This is because the combination of the materials of the lenses A11 and A12 included in the compound lens A1 is not ideal, and is caused by a difference between the refractive indexes. If the field angle of the principal focus correction optical system 100 is made larger to 1.5 degrees or more, the compound lens A1 is inevitably substantially increased in size, and the effective diameter exceeds 600 mm in the reflecting telescope 1 of the first exemplary embodiment.

Manufacturing of such a large optical material is difficult, and in reality, types of materials that can be used are strictly restricted. Therefore, in reality, it is unavoidable to form the reflecting telescope 1 under the restriction that the ideal combination of the optical materials in which the refractive indexes are almost the same but only the dispersion is different cannot be selected.

Therefore, the reflecting telescope 1 according to the present exemplary embodiment includes a unit to correct influence of aberration deterioration caused by movement of the compound lens A1.

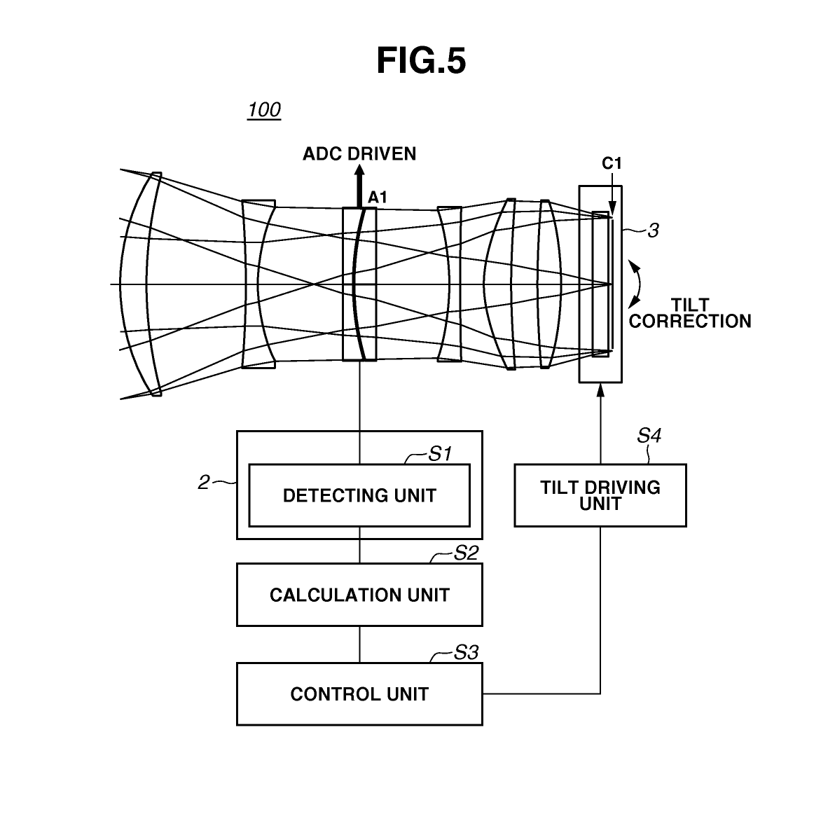

FIG. 5 is a principal part schematic diagram of the correction optical system 100 having a unit to correct the aberration deterioration according to the present exemplary embodiment. FIG. 5 illustrates a configuration for correcting the aberration deterioration due to the movement of the compound lens A1. In FIG. 5, a detecting unit S1 detects a driving amount of the compound lens A1 related to a component in the vertical direction with respect to the optical axis. A calculation unit S2 calculates a tilt correction amount of the image sensor 3 from the driving amount of the compound lens A1 detected by the detecting unit S1. A control unit S3 changes a tilt angle of the image sensor 3 from the correction amount calculated by the calculation unit S2. A tilt driving unit S4 tilts the image sensor 3 based on a control signal from the control unit S3.

An operation of the present exemplary embodiment will be described. When observing an astronomical object in a direction distant from the zenith through the reflecting telescope 1, a differential driving amount of the compound lens A1 (ADC) with respect to the optical axis is determined according to the zenith distance of a target astronomical object. An optimum driving amount of the compound lens A1 with respect to the optical axis corresponding to the zenith distance is prepared in a form of a numerical value table calculated from optical design values or a numerical expression. The detecting unit S1 is incorporated in the driving unit (ADC driving unit) 2 for driving the compound lens A1, and detects how far the compound lens A1 is moved.

The driving unit 2 may be separately provided from the detecting unit S1. As the detecting unit S1 to which the driving unit 2 is incorporated, a photoelectric scale-system encoder, an interferometric system encoder, or the like can be used. In addition, when driving accuracy of the driving unit 2 is sufficiently favorable, an indicated value of the driving amount of the compound lens A1 may be employed as a detection result.

Next, the calculation unit S2 that calculates the correction amount calculates an aberration generation amount in each angle of view estimated from the moving amount of the compound lens A1 detected by the detecting unit S1. The aberration generation amount referred here includes a component of focus variation due to the angle of view. The relationship between the moving amount of the compound lens A1 and the aberration generation amount is calculated from an optical design parameter by ray tracing. However, in reality, a result calculated in advance may just be prepared in a form of a numerical value table or an approximate expression.

In the calculation unit S2, a sensitivity table of aberration change with respect to driving of the image sensor 3 is prepared in advance. The calculation unit S2 calculates the tilt correction amount of the image sensor 3 with respect to the optical axis, with which estimated influence of aberration can be minimized over the entire FOV, by optimization calculation using the sensitivity table.

Next, the control unit S3 that controls the tilt of the image sensor 3 drives the tilt driving unit (actuator) S4 in synchronization with movement of the compound lens A1 so that a relative tilt between the principal focus correction optical system 100 and the image sensor 3 is changed by the correction amount determined by the calculation unit S2. With the above-described procedure, the operator can perform the astronomical object observation through the reflecting telescope in a state where the influence of the aberration deterioration associated with the movement of the compound lens A1 is decreased.

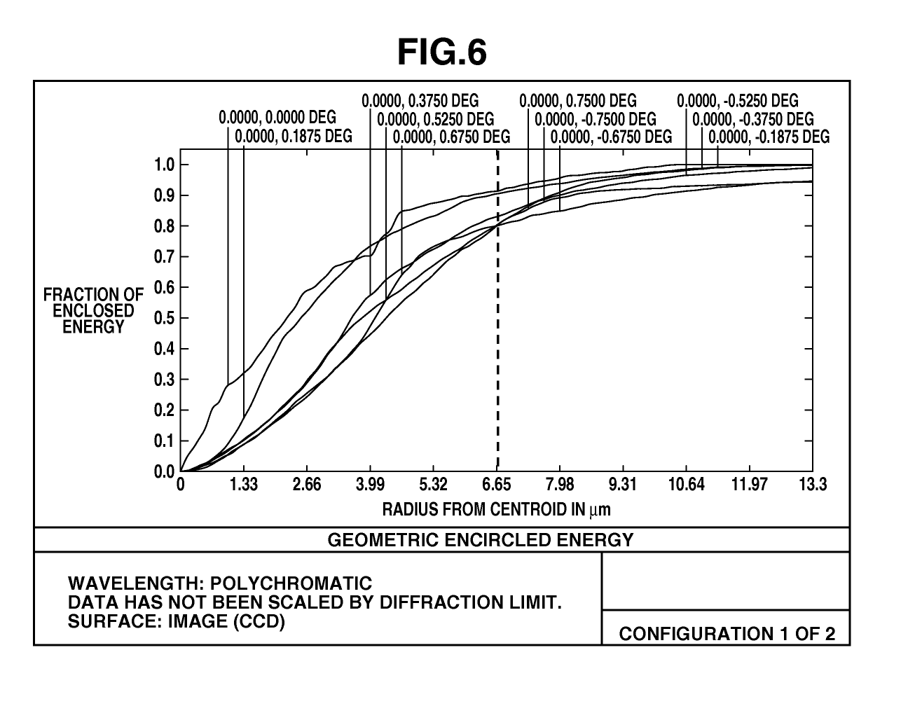

FIG. 6 illustrates an encircled energy diagram in a state where the compound lens A1 is not driven when an operator observes an astronomical object in the zenith direction with the reflecting telescope according to the present exemplary embodiment. A calculation wavelength is a wavelength of when observation is performed using a red filter that transmits wavelengths of 570 to 670 nm. The horizontal axis indicates a spot radius in which a light flux from the astronomical object is focused on the imaging plane C1, in a micron unit. The vertical axis indicates a ratio of optical energy included in the spot radius.

The plurality of curves drawn in FIG. 6 represents encircled energy in different field positions. The dotted line vertically drawn in FIG. 6 represents the spot radius including 80% energy in a worst field position, and is an indication of evaluation of the image forming performance.

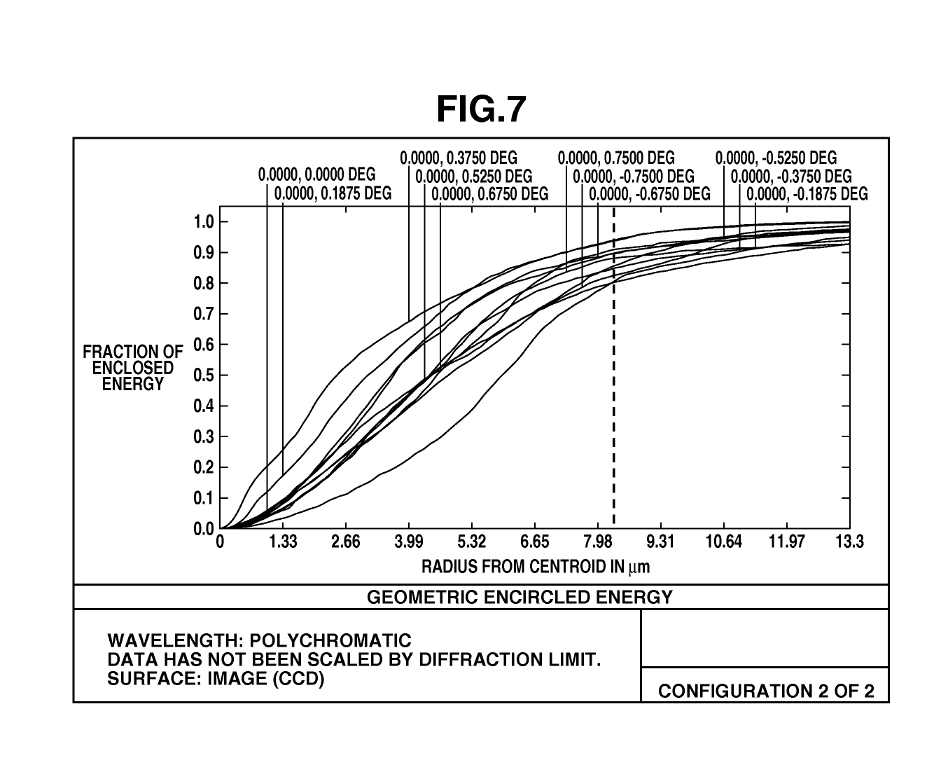

FIG. 7 is an encircled energy diagram of when an operator observes an astronomical object positioned in the zenith distance of 60°, which is the largest zenith distance assumed in the principal focus correction optical system 100 according to the present exemplary embodiment. In this case, the influence of the atmospheric dispersion is maximized, and the driving amount of the compound lens A1 becomes about 22 mm, which is the maximum amount, to correct the atmospheric dispersion. As can be seen from comparison with FIG. 6, a coma aberration and a tilt of the image plane are considerably generated due to driving of the compound lens A1, and the image forming performance is decreased. Even in such a case, substantially higher image forming performance can be obtained than a case where the compound lens A1 is not driven, that is, a case where the influence of the atmospheric dispersion is not corrected.

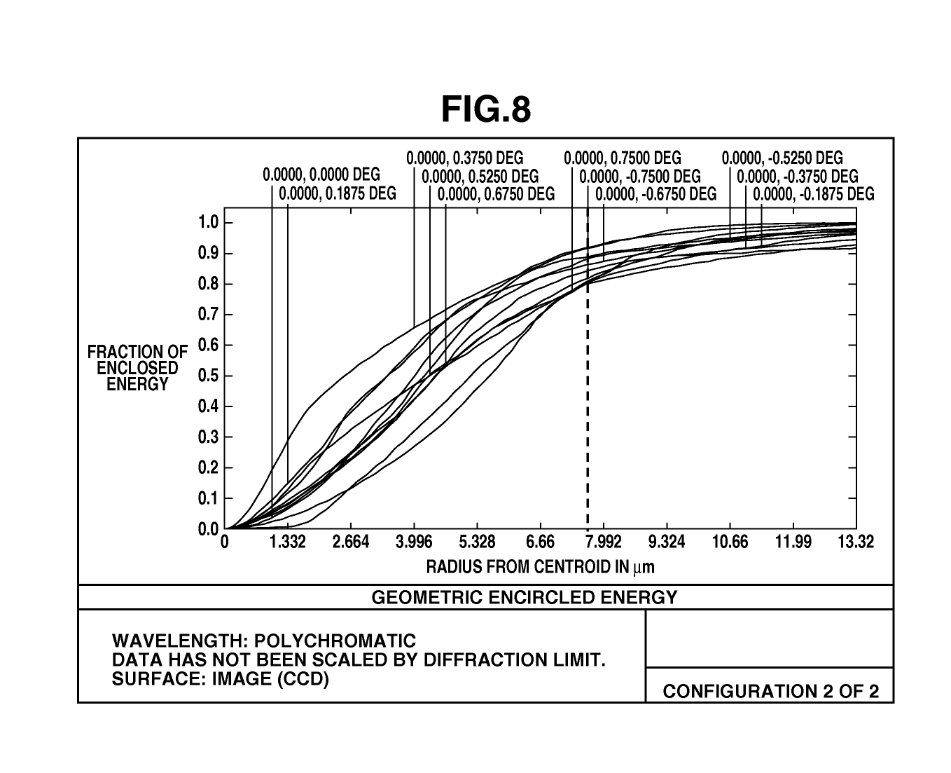

FIG. 8 is an encircled energy diagram of a result of application of the present invention when an operator observes an astronomical object positioned in the zenith distance of 60°. The tilt of the image sensor 3 is tilted by about 11 arc-seconds)(0.003° with respect to the principal focus correction optical system 100 to correct the tilt of the image plane and the coma aberration due to the driving of the compound lens A1. Accordingly, asymmetry of the aberrations in the field direction into which the compound lens A1 is driven and in an opposite direction is improved, and the image forming performance is improved even in the worst field position as illustrated in FIG. 8.

The present exemplary embodiment optimizes and corrects the tilt of the image sensor 3 when performing observation with a red filter that transmits the wavelengths of 570 to 670 nm. However, the correction amount can be individually set for each filter wavelength to be used.

As described above, according to the present exemplary embodiment, even when the compound lens includes two types of materials having a difference between the refractive indexes by 0.5% or more, the compound lens can exert the atmospheric dispersion correction effects without impairing sharpness of the star image. Therefore, a reflecting telescope can be obtained, which has an atmospheric dispersion correction function and is capable of performing observation in a principal focus with a larger FOV and with a higher resolution than conventional ones.

In the above-described exemplary embodiment, an example of the FOV of 1.5° has been described. However, the FOV is not limited to the value but can employ other values. For example, the present invention is applicable to different FOV, such as 1.2° or 2.0°.

Further, in the above-described exemplary embodiment, an example of using the compound lens A1 in which the light incident-side surface and the light emission-side surface are planes or spherical surfaces having large curvature radiuses, and moving the compound lens A1 in the direction having a component perpendicular to the optical axis to correct the atmospheric dispersion has been described.

However, a compound lens A1 having a configuration other than the above-described configuration may be used. For example, as described in U.S. Pat. No. 6,038,068, a system of correcting the atmospheric dispersion by using a compound lens, both end surfaces of which have concentric spherical shapes, and rotating the compound lens around the curvature center as a rotation center.

According to the present exemplary embodiment, the atmospheric dispersion correction effect can be exerted while the sharpness of the star image is maintained. Therefore, a reflecting telescope having an atmospheric dispersion correction function, and capable of observing an astronomical object with a large field angle can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-188224 filed Sep. 11, 2013, which is hereby incorporated by reference herein in its entirety.

What is claimed is:

1. A reflecting telescope comprising:
a reflecting mirror having an image forming function;
a correction optical system configured to receive light reflected at the reflecting mirror, and including a compound lens including a positive lens and a negative lens in which a difference of refractive indexes of materials is 0.5% or more, and configured to be moved in a direction having a component of a vertical direction with respect to an optical axis;
an image sensor configured to receive the light through the correction optical system;
a detecting unit configured to detect a driving amount of the compound lens; and
a control unit configured to tilt the image sensor with respect to the optical axis based on the driving amount of the compound lens detected by the detecting unit.

2. The telescope according to claim 1, wherein the difference of refractive indexes of materials of the positive lens and the negative lens of the compound lens is 5% or less, and the positive lens and the negative lens are adjacently arranged in an optical axis direction.

3. The telescope according to claim 1, wherein a light incident-side surface of and a light emission-side surface of the compound lens are planes.

4. The telescope according to claim 1, wherein the positive lens and the negative lens that constitute the compound lens are adjacently arranged, and an air layer exists between the positive lens and the negative lens.

5. The telescope according to claim 1, wherein the positive lens and the negative lens that constitute the compound lens are adjacently arranged, and a negative lens-side surface of the positive lens and a positive lens-side surface of the negative lens have mutually different curvature radiuses.

6. The telescope according to claim 1, wherein the positive lens and the negative lens of the compound lens are made of materials having mutually different dispersion, and the positive lens and the negative lens are adjacently arranged in a state of being bonded, or in a state of being through an air layer.

7. The telescope according to claim 1, wherein a conditional expression of
0.95<Rn/Rp<1.05
is satisfied where curvature radiuses of facing lens surfaces of the positive lens and the negative lens of the compound lens are Rp and Rn, respectively.

8. The telescope according to claim 1, further comprising:
a zenith distance detecting unit configured to detect a angle from zenith; and
a driving unit configured to move the compound lens based on a detection result from the zenith distance detecting unit.
